(19) United States
(12) Patent Application Publication
(10) Pub. No.: US 2017/0128953 A1
(43) Pub. Date: May 11, 2017

(54) DIVERTER ROLLER FOR A NON FERROUS WASTE SEPARATOR, AS WELL AS NON FERROUS WASTE SEPARATOR PROVIDED WITH THE DIVERTER ROLLER

(71) Applicant: GOUDSMIT MAGNETIC SYSTEMS B.V., WAALRE (NL)

(72) Inventors: GER SLEGERS, HELMOND (NL); DENNIS DIEJEN, VAN, HELMOND (NL)

(21) Appl. No.: 15/317,945

(22) PCT Filed: Jul. 6, 2015
(86) PCT No.: PCT/NL2015/050493

§ 371 Date: Dec. 11, 2016

(30) Foreign Application Priority Data
Jul. 4, 2014 (NL) 2013128

(51) Int. Cl. B03C 1/247; B03C 1/033

(52) U.S. Cl. CPC B03C 1/247; B03C 1/0332; B03C 2201/20

(57) ABSTRACT

A waste separator has two diverter rollers around which an endless conveyor belt is led. One of the diverter rollers is provided with an Eddy current separator for separating non ferrous metal parts from a waste stream. This diverter roller 5 has a hollow roller 15 which is bearing mounted on discs 19. A magnet rotor 23 is eccentrically present in the roller 15, which rotor is provided with permanent magnets 31, 33.; The roller 15 accommodates a cooling duct 39 through which a cooling agent is pumped for cooling the space 45 inside the roller. It has turned out that owing to the rotation of the magnet rotor turbulent air swirls evolve inside the roller which lead to development of heat in the roller and in the bearings of the roller. Owing to this development of heat the roller becomes weak which leads to vibrations. The source of the vibrations and of the development of heat inside the roller is eliminated by installing a cooling system in the roller.

### FIELD OF THE INVENTION

The invention relates to a diverter roller for a waste separator for separating non ferrous metal parts from waste, comprising:
a hollow roller for diverting a conveyor belt,
two bearing carriers carrying bearings the roller rotates on,
a magnet rotor which runs parallel to and extends in the roller and is provided with a cylinder wall that includes magnets and is provided with at least one rotor shaft that is bearing mounted in the bearing carriers eccentrically relative to the roller.

The invention likewise relates to a waste separator for separating non ferrous metal parts from waste and comprising a diverter roller of this type. This waste separator further includes a frame as well as an endless conveyor belt, two conveyor-belt-carrying diverter rollers bearing mounted in the frame, where one of the diverter rollers is formed by the diverter roller described above, and drive means connected to one of the diverter rollers for driving the conveyor belt.

A waste separator of this type is used inter alia for separating non ferrous metal parts from slag from an incinerator. The rotating magnet-comprising magnet rotor forms a what is termed an Eddy current separator. The rotating magnets generate an alternating magnetic field in a waste stream supplied by the conveyor belt. This alternating magnetic field induces a current into the non ferrous metal parts in the waste stream, which non ferrous metal parts consequently obtain magnetic properties and are repelled and while being repelled cross a separating partition and end up in a receptacle.

In a waste separator of this type the magnet rotor rotates at 3000 to 5000 rotations per minute and in the future probably even faster for processing the waste stream.

### STATE OF THE ART

A waste separator of this type is generally known. A problem experienced with the known waste separator is that during operation vibrations in the roller are developed and the bearings become heated.

### SUMMARY OF THE INVENTION

It is an object of the invention to provide a diverter roller of the type defined in the opening paragraph where, when used in a waste separator, no or at any rate less vibration takes place during operation than in the known waste separator. For this purpose the diverter roller according to the invention is characterized in that the diverter roller is provided with a cooling duct and a supply connecting piece and a discharge connecting piece connected to this duct for connecting the cooling duct to a pump which can pump a cooling agent through the cooling duct, which cooling duct extends in the roller in the space between the jacket of the roller and the cylinder wall of the magnet rotor. It has turned out that as a result of the rotation of the magnet rotor turbulent air swirls are developed in the roller which may lead to development of heat in the roller and in the bearings of the roller. This development of heat renders the roller weak which leads to vibrations. Thus the cause of the vibrations is the development of heat as a result of the rotating magnet rotor. By finding the cause of the vibrations and development of heat in the roller, the problem may be solved. The solution utilized for solving the problem in the waste separator according to the invention is the introduction of cooling inside the roller. By doing this, the cooling is located close to the source of the development of heat so that the cooling takes place most effectively. Preferably, liquid cooling is used, but air cooling is also an option.

An embodiment of the diverter roller according to the invention is characterized in that the cooling duct is formed by an elongated hollow bridge part which extend in the roller in axial direction of the roller and is connected with both ends to the bearing carriers. This bridge part provides a sturdy connection between the bearing carriers so that vibrations that might occur are limited. When used in a waste separator also the frame of the waste separator is strengthened which even further limits any further vibrations that may occur.

Preferably, a meander shaped duct is installed in the bridge part through which duct cooling agent is pumped. As a result, the cooling agent also reaches the corners of the bridge part, which leads to a larger effective cooling surface.

A further embodiment of the diverter roller according to the invention is characterized in that the bridge part is provided with a supply and a discharge opening for the cooling agent, which supply and discharge openings are located at either end of the bridge part. This simplifies the connecting of a pump and no long pipes are necessary as a result of this.

Yet a further embodiment of the diverter roller according to the invention is characterized in that the bearing carriers are formed by round discs. Both the roller and the magnet rotor may thus be bearing mounted in an advantageous manner by these discs.

Preferably the bridge part has a crescent-shaped cross section and the bridge part ends are fitted to the discs. This shape provides that the available space inside the roller is utilized for cooling purposes in the best possible way.

Furthermore, the diverter roller preferably comprises a drive motor that is connected to one of the bearing carriers and comprises a drive shaft which is coupled to the rotor shaft. By integrating the drive motor in the diverter roller, the connection to the rotor shaft and the fastening to the bearing carrier can be executed in the most advantageous manner.

The diverter roller further preferably comprises two mounting brackets which are connected with one end to the bearing carriers and can be connected with the other end to a frame of a waste separator. In consequence, the diverter roller may simply be installed as a module in a waste separator.

### BRIEF DESCRIPTION OF THE DRAWINGS

The invention will now be described in more detail based on an example of embodiment of the waste separator according to the invention represented in the drawings, wherein:

FIG. 1 shows a perspective view of an embodiment of the waste separator according to the invention;

FIG. 2 shows a perspective view of a cutaway diverter roller accommodating a magnet rotor;

FIG. 3 shows a longitudinal sectional view of the diverter roller accommodating the magnet rotor and the bearings;

FIG. 4 shows a side view of the diverter roller accommodating bearings shown in FIG. 3;

FIG. 5 shows a top view of the bridge part of the diverter roller; and

FIG. 6 shows a side view of the bridge part shown in FIG. 5.

### DETAILED DESCRIPTION OF THE DRAWINGS

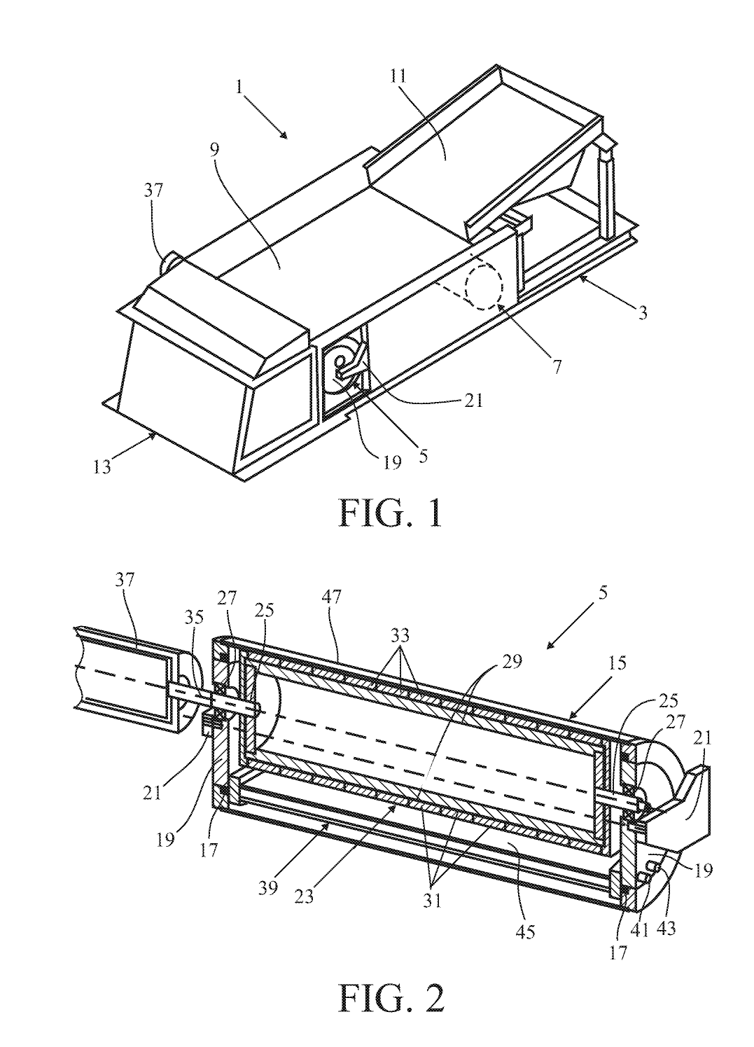

FIG. 1 shows a perspective view of an embodiment of the waste separator according to the invention. The waste separator 1 comprises a frame 3 in which two diverter rollers 5 and 7 are bearing mounted around which an endless conveyor belt 9 is led. The rear diverter roller 7 is connected to drive means (not shown in the drawing figure) and the front diverter roller 5 is provided with an Eddy current separator. At the rear end of the conveyor belt there is a supply funnel 11 via which the waste to be separated is supplied. At the front end of the conveyor belt there is a discharge funnel (not shown in the drawing figure) via which the waste coming from the conveyor belt is discharged, as well as a receptacle 13 for the non ferrous parts flying off.

The front diverter roller 5 provided with the Eddy current separator comprises a hollow roller 15 which is bearing mounted on both ends via bearings 17 on bearing carriers that are formed by discs 19 which are connected to the frame by means of the mounting brackets 21. This is clearly visible in FIG. 2 in which the cutaway diverter roller 5 is shown in a perspective view. The roller 15 accommodates a magnet rotor 23 which runs parallel to the roller and at the ends has two rotor shafts 25 which are bearing mounted in the discs 19 by means of further bearings 27. These further bearings 27 are eccentrically positioned in the discs 19. The cylinder wall 29 of the magnet rotor is provided with a large number of permanent magnets 31 and 33.

One of the rotor shafts 25 is connected to a drive shaft 35 of a drive motor formed by an electromotor 37 which is mounted to one of the discs 19. During operation the magnet rotor 23 rotates at 3000 to 4000 revolutions per minute for processing the waste stream.

The roller 15 further accommodates a cooling duct 39 through which a cooling agent is pumped during operation. To the cooling duct are connected a supply connecting piece 41 and a discharge connecting piece 43 for connecting the cooling duct to a pump which can pump a cooling agent through the cooling duct. The cooling duct 39 together with a pump (not shown) forms cooling means for cooling the space 45 in the roller and thus indirectly also for cooling the roller 15 and more specifically the roller jacket 47.

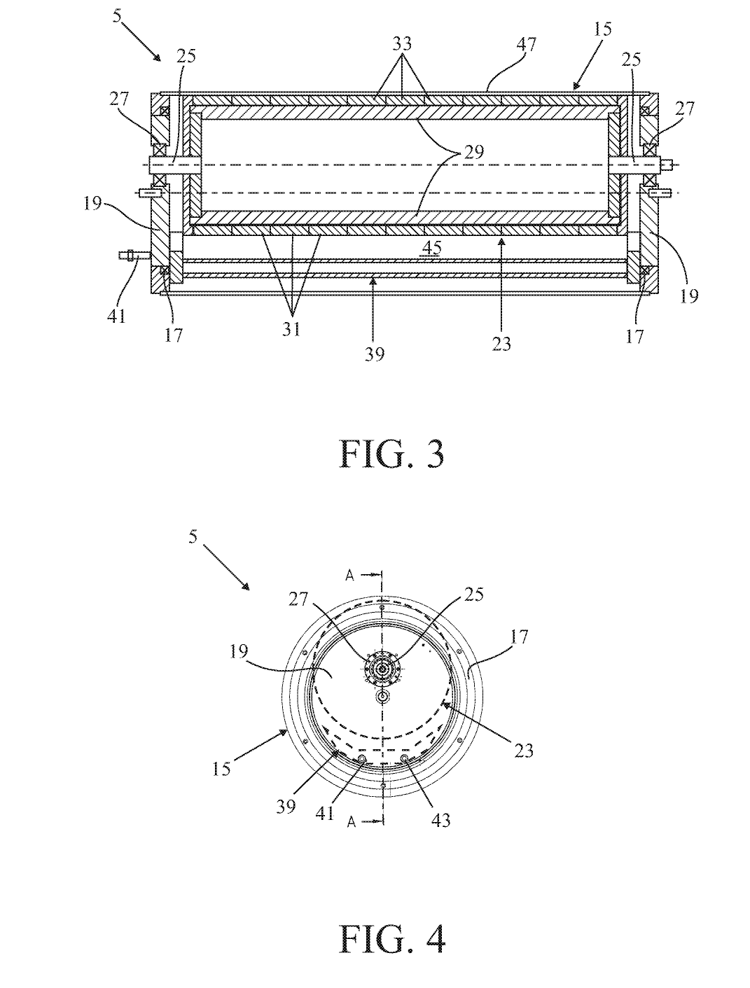

In FIGS. 3 and 4 the diverter roller is shown in a longitudinal sectional view along line A-A and in a side view respectively for clarity. It has turned out that as a result of the rotation of the magnet rotor 23 turbulent air swirls evolve in the roller 15 which lead to development of heat in the roller and in the bearings 17 and 27 of the roller. Owing to this development of heat the roller and more specifically the jacket 47 of the roller becomes weak which leads to vibrations. The source of the vibrations and of the development of heat in the roller 15 is eliminated by installing a cooling system in the roller. As a result, the cooling system is then located close to the source of the development of heat so that this is combated effectively.

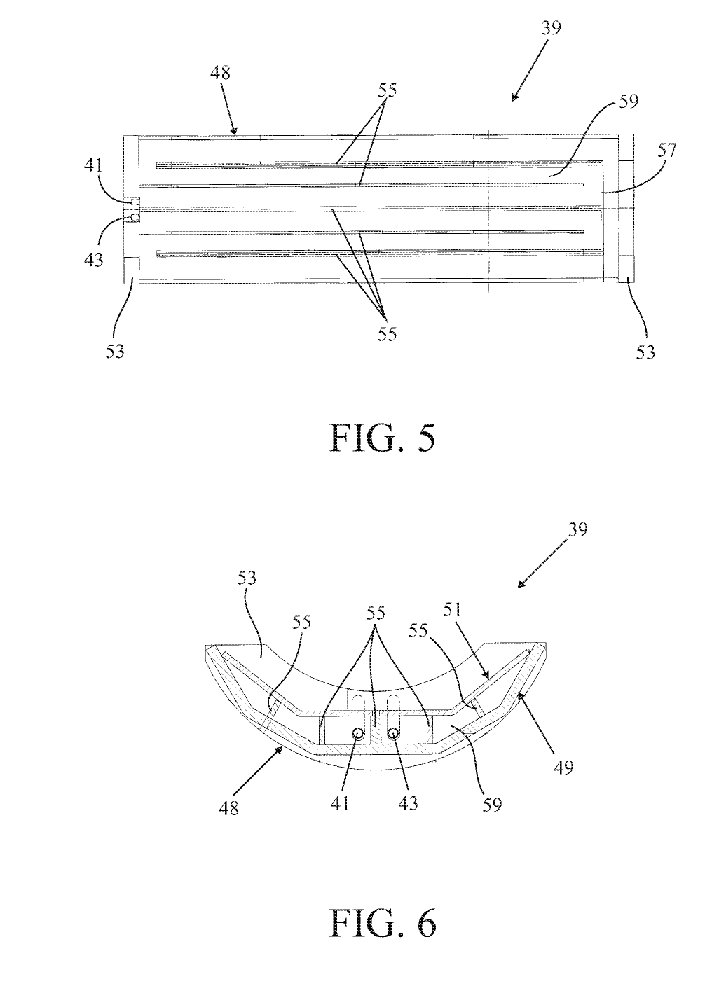

In FIGS. 5 and 6 is shown the cooling duct 39 of the diverter roller in a top view and side view respectively. The cooling duct is formed by an elongated hollow bridge part 48 which extends in axial direction of the roller in the space 45 (see FIG. 3) between the jacket 47 of the roller 15 and the cylinder wall 29 of the magnet rotor 23 and is mounted with both ends to the discs 19. The bridge part has a crescent shaped cross section (see FIG. 6) and is formed by two wall portions 49 and 51 fixed together and two flanges 53 which are mounted to the ends of the wall portions. Between these wall portions are positioned partitions 55 which extend in longitudinal direction of the bridge part and a cross plate 57 which extends at right angles to the partitions, as a result of which a meandering duct 59 is formed in the bridge part (see FIG. 5). The supply connecting piece 41 and the discharge connecting piece 43 are located at either end of the bridge part.

Albeit the invention has been described in the foregoing with reference to the drawings, it should be observed that the invention is not by any manner or means restricted to the embodiments shown in the drawings. The invention also extends to all embodiments deviating from the embodiments shown in the drawings within the scope defined by the claims.

1. A diverter roller for a waste separator for separating non ferrous metal parts from waste, comprising:
a hollow roller for diverting a conveyor belt,
two bearing carriers carrying bearings the roller rotates on,
a magnet rotor which runs parallel to and extends in the roller and is provided with a cylinder wall that includes magnets and is provided with at least one rotor shaft that is bearing mounted in the bearing carriers eccentrically relative to the roller, wherein the diverter roller is provided with a cooling duct and a supply connecting piece and a discharge connecting piece connected to this duct for connecting the cooling duct to a pump which can pump a cooling agent through the cooling duct, which cooling duct extends in the roller in the space between the jacket of the roller and the cylinder wall of the magnet rotor.

2. A diverter roller as claimed in claim 1, wherein the cooling duct is formed by an elongated hollow bridge part which extends in the roller in axial direction of the roller and is connected with both ends to the bearing carriers.

3. A diverter roller as claimed in claim 2, wherein the bridge part accommodates a meandering duct through which cooling agent can be pumped.

4. A diverter roller as claimed in claim 3, wherein the supply connecting piece and the discharge connecting piece are located at either end of the bridge part.

5. A diverter roller as claimed in claim 2, wherein the bearing carriers are formed by round discs.

6. A diverter roller as claimed in claim 5, wherein the bridge part has a crescent shaped cross section and the bridge part ends are fitted to the discs.

7. A diverter roller as claimed in claim 1, wherein the diverter roller further includes a drive motor that is connected to one of the bearing carriers and comprises a drive shaft which is coupled to the rotor shaft.

8. A diverter roller as claimed in claim 1, wherein the diverter roller comprises two mounting brackets which are connected with one end to the bearing carriers and can be connected with the other end to a frame of a waste separator.

9. A waste separator for separating non ferrous metal parts from waste, comprising:
a frame,
an endless conveyor belt,
two conveyor-belt-carrying diverter rollers bearing-mounted in the frame, and
drive means connected to one of the diverter rollers for driving the conveyor belt, wherein one of the diverter rollers comprising:
a hollow roller for diverting a conveyor belt,
two bearing carriers carrying bearings the roller rotates on,
a magnet rotor which runs parallel to and extends in the roller and is provided with a cylinder wall that includes magnets and is provided with at least one rotor shaft that is bearing mounted in the bearing carriers eccentrically relative to the roller,
and being provided with a cooling duct and a supply connecting piece and a discharge connecting piece connected to this duct for connecting the cooling duct to a pump which can pump a cooling agent through the cooling duct, which cooling duct extends in the roller in the space between the jacket of the roller and the cylinder wall of the magnet rotor.

10. A waste separator as claimed in claim 9, wherein the cooling duct is formed by an elongated hollow bridge part which extends in the roller in axial direction of the roller and is connected with both ends to the bearing carriers.
